(19) United States
(12) Patent Application Publication
(10) Pub. No.: US 2013/0203443 A1
(43) Pub. Date: Aug. 8, 2013

(54) PROVIDING INFORMATION ABOUT A LOCATION TO A MOBILE DEVICE BASED ON THE LOCATION OF THE MOBILE DEVICE

(71) Applicants: Joshua Aaron Heater, Cottonwood Heights, UT (US); Edwin Joseph Heater, Eden, UT (US); Derek Cromwell Strickland, Tallahassee, FL (US)

(72) Inventors: Joshua Aaron Heater, Cottonwood Heights, UT (US); Edwin Joseph Heater, Eden, UT (US); Derek Cromwell Strickland, Tallahassee, FL (US)

(21) Appl. No.: 13/733,059

(22) Filed: Jan. 2, 2013

Related U.S. Application Data
(60) Provisional application No. 61/594,782, filed on Feb. 3, 2012.

(51) Int. Cl. H04W 4/02

(52) U.S. Cl. CPC H04W 4/021
USPC 455/456.3

(57) ABSTRACT

The present invention extends to methods, systems, and computer program products for providing information (e.g. advertisements) to a mobile device based on the location of the mobile device. The location of a mobile device can be tracked to determine when to provide the information to the mobile device. After information has been displayed on the mobile device, the location of the mobile device can be tracked to determine whether the mobile device comes within a specified proximity of a location associated with the information. For example, the information can be for an event at a first location. The invention can track whether and when the mobile device comes within a specified proximity of the first location after the information for the event is displayed.

### CROSS-REFERENCE TO RELATED APPLICATIONS

This application claims priority to U.S. Provisional Application No. 61/594,782, filed Feb. 3, 2012.

### BACKGROUND

The present invention generally relates to the provision of information about a location, and in particular, to providing information about a location to a mobile device based on the location of the mobile device. In current advertising systems, an entity desiring to provide information relevant to a location has no way to track whether the publication of the information and a subsequent viewing of the information by an interested party resulted in a physical visit from that interested party.

Current systems that attempt to achieve this level of tracking rely on humans to interact and share information and possibly do data entry of some sort to close the tracking loop for the sponsoring entity. Inherently, this approach is inadequate in that it relies on user action to verify the arrival of the recipient at the target location. A typical application of this type would normally take place during a transactional process such as a purchase. These systems attempt to track coupon delivery, and customer response, by reporting a promo code of some variety to a person working for the sponsoring entity during the purchase at the destination location.

Another scenario requires a pre-purchased coupon over the internet. These pre-purchases are authenticated when the coupon is delivered to a person working for the sponsoring entity at the destination location. The drawbacks in this system are twofold. Firstly, these systems require high overhead of sales personnel who contact and write ads for the merchant. Secondly, the resulting sales transactions created by these ads are posted to a third party clearing house and large percentage based fees are applied to the transaction as a whole. This delays the routing of monies to the content providers, is cumbersome to manage, is inefficient in terms of scaling to new sponsoring entities, and impacts the sponsoring entity's ability to manage profit margins since fees are applied on a percentage basis against the transaction as a whole.

### BRIEF SUMMARY

The present invention extends to methods, systems, and computer program products for providing information (e.g. advertisements) to a mobile device based on the location of the mobile device. The location of a mobile device can be tracked to determine when to provide the information to the mobile device. After information has been displayed on the mobile device, the location of the mobile device can be tracked to determine whether the mobile device comes within a specified proximity of a location associated with the information. For example, the information can be for an event at a first location. The invention can track whether and when the mobile device comes within a specified proximity of the first location after the information for the event is displayed.

In one embodiment, information is provided to a mobile device based on the location of the mobile device. In this embodiment, content is received from a content provider. The content includes information content and location content with the location content identifying a first and a second zone. The first zone comprises a distance around a current location of a mobile device on which it is desired that the information content be displayed, and the second zone comprises a distance around a physical location identified in the location content.

A first zone of a first mobile device is determined based on a current location of the first mobile device. It is then determined that the physical location is within the first zone of the first mobile device. In response, the information content is provided to the first mobile device so that the information content is displayed on the first mobile device when the first zone of the first mobile device encompasses the physical location.

An indication is then received that the current location of the first mobile device has changed such that the current location is within the second zone. An indication of an arrival event for the first mobile device is stored thereby indicating that the first mobile device has entered within the second zone.

In another embodiment, information is provided to a mobile device based on the location of the mobile device. In this embodiment, the content includes advertisement content and location content. The location content defines a first zone and a second zone around a location. The information content is to be displayed on a mobile device when the mobile device enters the first zone, and an arrival event is to be generated when a mobile device on which the information content has been displayed has entered the second zone.

It is determined that a first mobile device has entered the first zone, and the information content is provided to the first mobile device so that the information content is displayed on the first mobile device when the first mobile device is within the first zone. An indication is received that the first mobile device has entered the second zone after the information content was displayed on the first mobile device. An indication of an arrival event for the first mobile device is then stored.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIG. 2 illustrates an exemplary data structure for specifying advertisement and location content;

FIGS. 3A-3C illustrate a first exemplary implementation of the present invention;

FIGS. 4A-4C illustrate a second exemplary implementation of the invention;

FIG. 5 illustrates a flowchart of an exemplary method for providing information to a mobile device based on the location of the mobile device; and

FIG. 6 illustrates a flowchart of another exemplary method for providing information to a mobile device based on the location of the mobile device.

### DETAILED DESCRIPTION

The present invention extends to methods, systems, and computer program products for providing information (e.g. advertisements) to a mobile device based on the location of the mobile device. The location of a mobile device can be tracked to determine when to provide the information to the mobile device. After information has been displayed on the mobile device, the location of the mobile device can be tracked to determine whether the mobile device comes within a specified proximity of a location associated with the information. For example, the information can be for an event at a first location. The invention can track whether and when the mobile device comes within a specified proximity of the first location after the information for the event is displayed.

In one embodiment, information is provided to a mobile device based on the location of the mobile device. In this embodiment, content is received from a content provider. The content includes information content and location content with the location content identifying a first and a second zone. The first zone comprises a distance around a current location of a mobile device on which it is desired that the information content be displayed, and the second zone comprises a distance around a physical location identified in the location content.

A first zone of a first mobile device is determined based on a current location of the first mobile device. It is then determined that the physical location is within the first zone of the first mobile device. In response, the information content is provided to the first mobile device so that the information content is displayed on the first mobile device when the first zone of the first mobile device encompasses the physical location.

An indication is then received that the current location of the first mobile device has changed such that the current location is within the second zone. An indication of an arrival event for the first mobile device is stored thereby indicating that the first mobile device has entered within the second zone.

In another embodiment, information is provided to a mobile device based on the location of the mobile device. In this embodiment, the content includes advertisement content and location content. The location content defines a first zone and a second zone around a location. The information content is to be displayed on a mobile device when the mobile device enters the first zone, and an arrival event is to be generated when a mobile device on which the information content has been displayed has entered the second zone.

It is determined that a first mobile device has entered the first zone, and the information content is provided to the first mobile device so that the information content is displayed on the first mobile device when the first mobile device is within the first zone. An indication is received that the first mobile device has entered the second zone after the information content was displayed on the first mobile device. An indication of an arrival event for the first mobile device is then stored.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

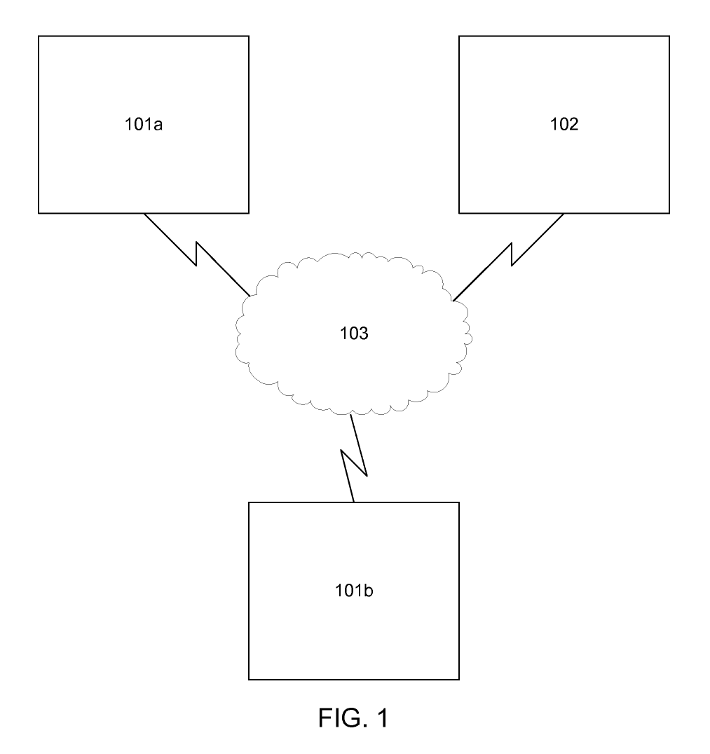

FIG. 1 illustrates an exemplary computer environment 100 in which the present invention can be implemented. Computer environment 100 includes server computer systems 101a and 101b and a mobile device 102 that are interconnected by network 103. In a typical implementation, mobile device 102 can be a smart phone or other web and GPS enabled mobile device which receives content over network 103 from server computer system 101a. Server computer system 101b (or any other source computer system) can provide this content to server computer system 101a.

Network 103 can represent any type of network over which mobile device 102 can send and receive content. For example, network 103 can comprise cellular networks, Wi-Fi networks, or any other suitable network.

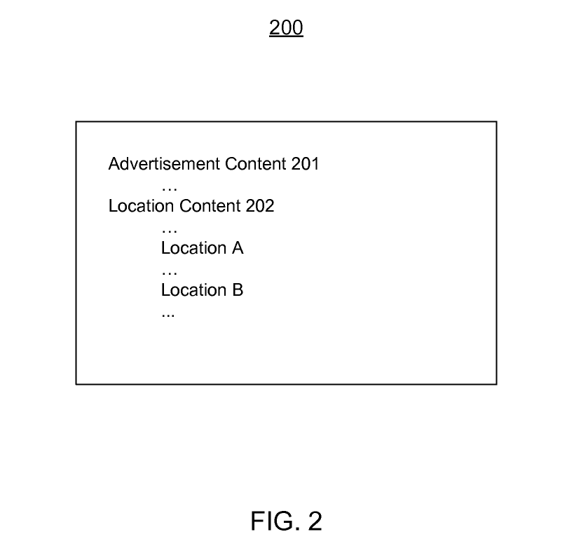

FIG. 2 illustrates an exemplary data structure 200 containing content that server computer system 101b can provide to server computer system 101a to facilitate location based advertisement tracking. As shown, data structure 200 includes information content 201 and location content 202. Information content 201 comprises the content to be displayed to a user of mobile device 102 (e.g. image, video, or audio content). Examples of information content 201 include advertisements for a store or other location, information for an event at a location (e.g. a concert or other entertainment at a location), real estate information (e.g. homes for sale), educational information about a location (e.g. a national park or historical site), etc. Location content 202 comprises an identification of at least two locations shown as location A and location B in data structure 200.

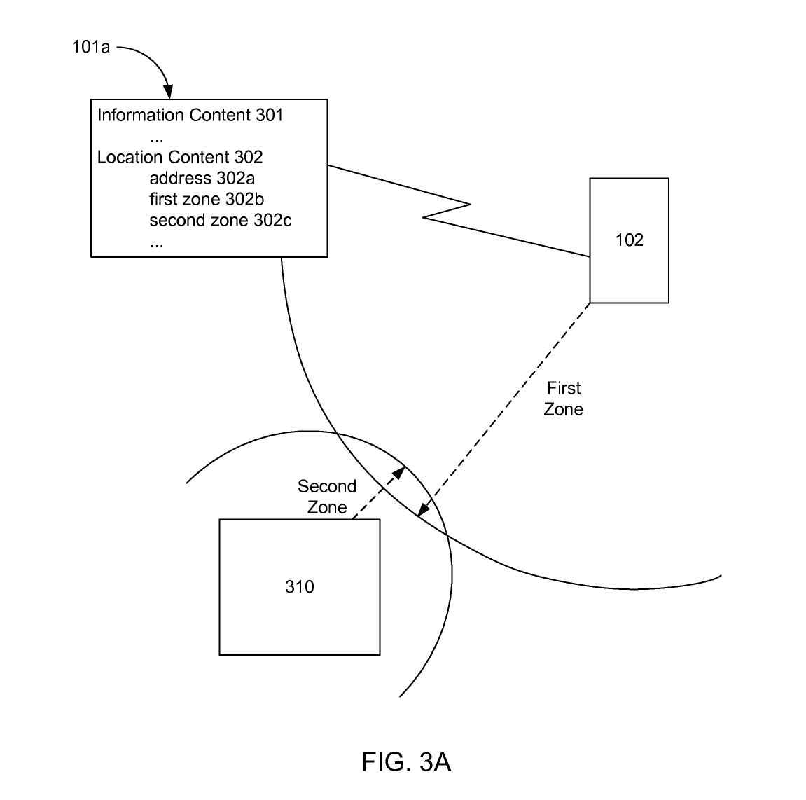

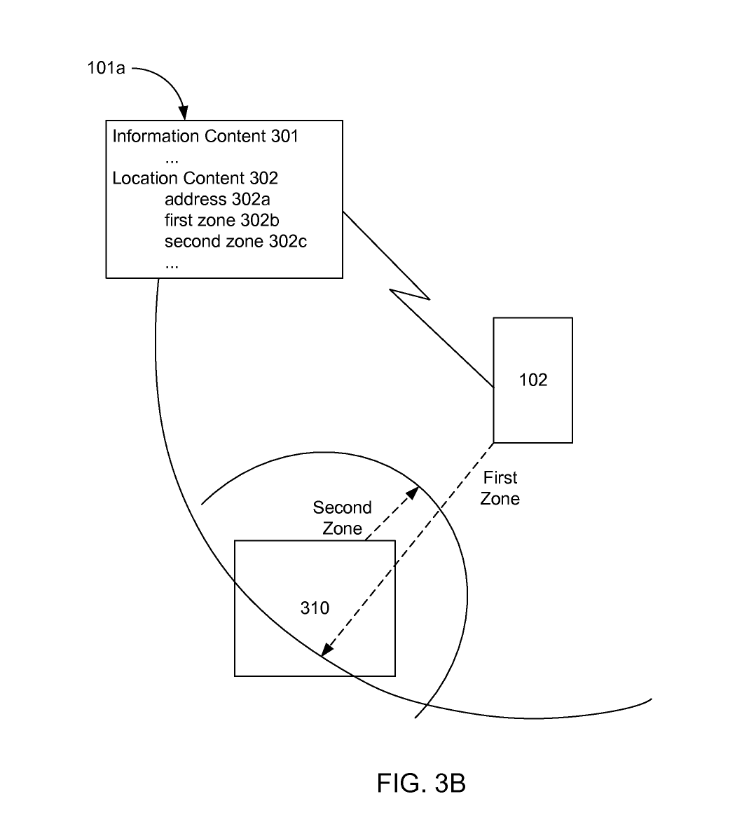

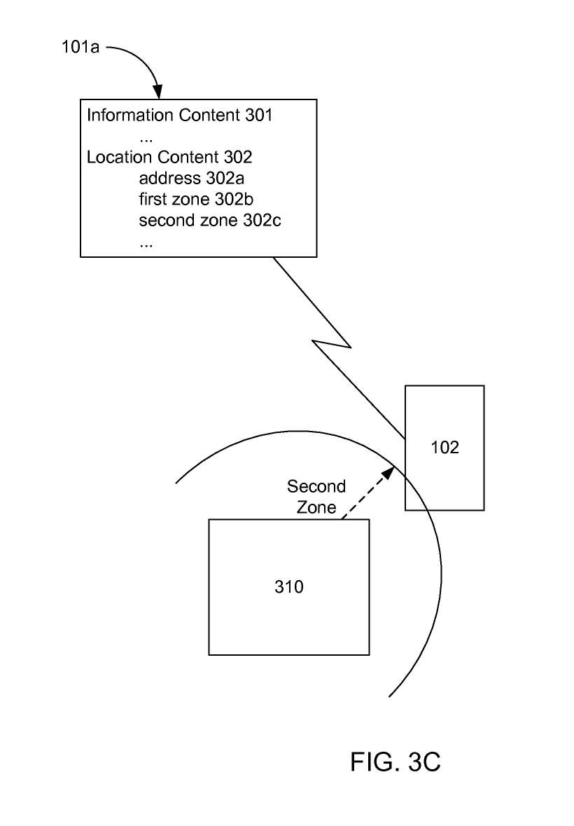

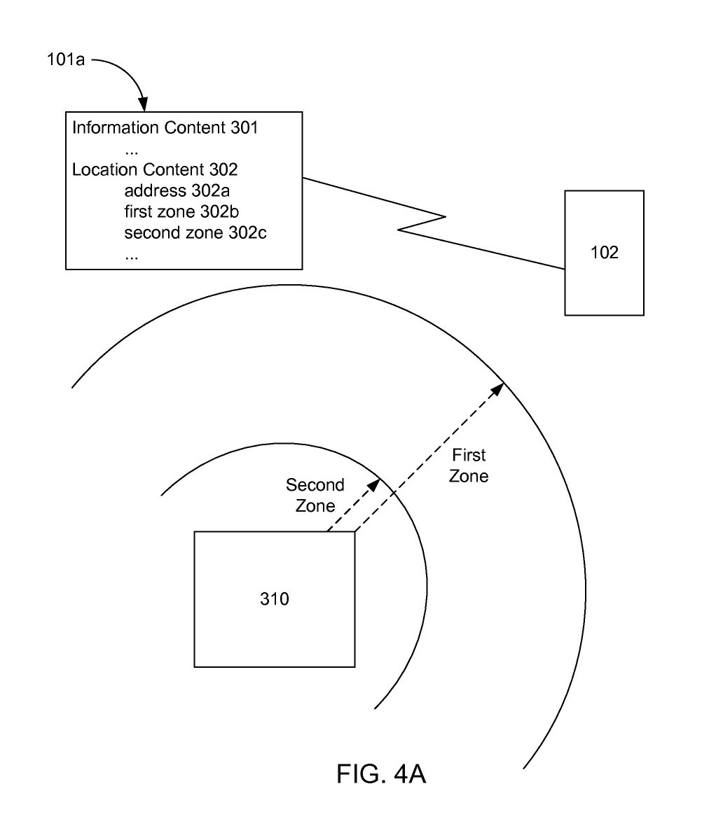

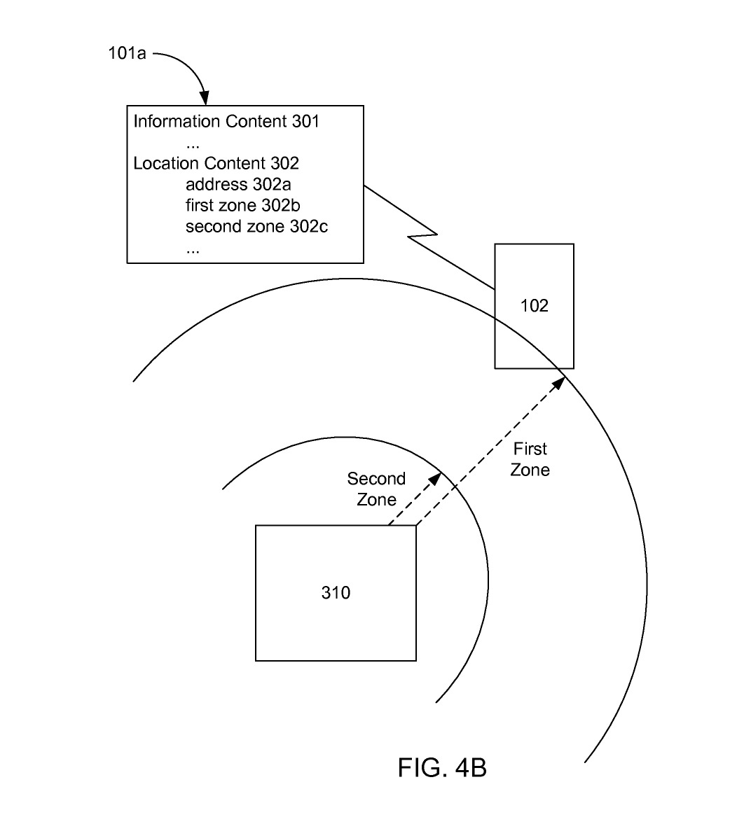

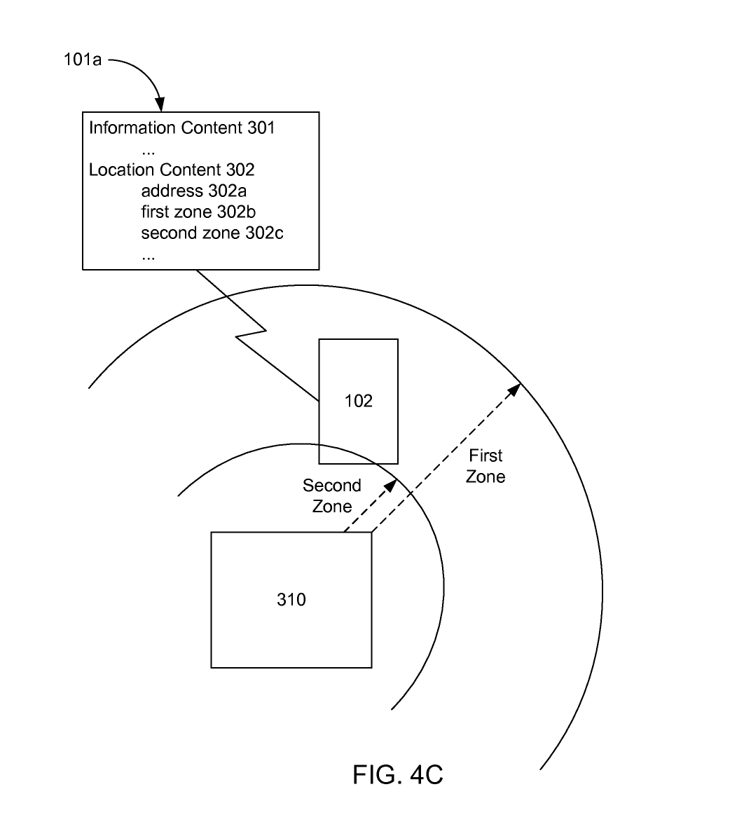

Location A can represent a first specified location and a first specified zone at which information content 201 should be displayed on mobile device 102. This first location can be represented as a specific location (e.g. an address, GPS coordinates, etc.), and as a distance from the specific location (e.g. a radius around a retail location), or as any other form that can define a relative distance from the specific location. As described more fully below with reference to FIGS. 3 and 4, location A can represent either a distance around a location or a distance around a mobile device.

Location B can represent a second specified location and a second specified zone at which an arrival event should be generated. An arrival event comprises an indication that the mobile device has come within the required distance of the second location after the associated information content has been displayed on the mobile device. For example, if the second specified location is fifty feet from a retail location, an arrival event can be generated when the mobile device comes within fifty feet of the retail location after an advertisement for the retail location has been displayed on the mobile device.

FIGS. 3A-3C illustrate computer environment 100 when information is provided to a mobile device for a location 310 based on the location of mobile device 102 according to a first embodiment of the invention. In the first embodiment depicted in FIG. 3, the first zone, which determines when information content is to be displayed on mobile device 102, is defined as a radius around the current location of mobile device 102. Similarly, the second zone, which determines when an arrival event has occurred for a mobile device, is defined as a radius around location 310.

As shown in FIGS. 3A-3C, server computer system 101a stores data structure 300 which defines information content 301 and location content 302 associated with location 310. Location 310 can represent a retail location (e.g. a grocery or department store), a restaurant, an entertainment venue, or any other type of location that desires to engage in advertisement.

Location content 302 provides an address 302a of location 310, a definition of the first zone 302b, and a definition of the second zone 302c. Server computer system 101a can use location content 302 to determine when to cause information content 301 to be displayed on mobile device 102.

FIG. 3A illustrates that first zone 302b defined around mobile device 102 does not yet encompass location 310. In FIG. 3B, however, mobile device 102 has moved sufficiently close to location 310 so that first zone 302b encompasses location 310. Accordingly, FIG. 3B represents the occurrence of an information display event. In other words, when the mobile device approaches location 310 so that the first zone encompasses location 310, an information display event occurs which causes information content 301 to be displayed on mobile device 102. For example, if location 310 is a retail store, information content 301 can be an advertisement of certain items that are on sale at the retail store.

FIG. 3C illustrates that mobile device 102 has continued approaching location 310 to the point that mobile device 102 is now located within second zone 302c. Accordingly, FIG. 3C represents the occurrence of an arrival event. When an arrival event occurs, some additional action can occur. For example, additional information content 301 can be displayed on mobile device 102 such as a promo code, a bar code, or a more detailed advertisement or offer for a particular item on sale at the retail store. Further details regarding possible responses to arrival events are provided below.

FIGS. 4A-4C illustrate computer environment 100 when information is provided to mobile device 102 for a location 310 based on the location of mobile device 102 according to a second embodiment. The second embodiment differs from the first embodiment in that the first zone is defined as a region around location 310 rather than a region around mobile device 102. As in FIGS. 3A-3C, FIGS. 4A-4C also show that server computer system 101a stores data structure 300 which defines information content 301 and location content 302 associated with location 310.

In this second embodiment, when mobile device 102 comes within first zone 302b, information content 301 can be displayed on the device. Then, if and when mobile device 102 comes within second zone 302c, an arrival event can be generated to indicate that mobile device 102 both displayed information content 301 and then entered second zone 302c.

FIG. 4A illustrates that mobile device 102 has not yet entered into first zone 302b. FIG. 4B illustrates that mobile device 102 has entered first zone 302b thus causing an information display event to occur. Finally, FIG. 4C illustrates that mobile device 102 has entered second zone 302c thus causing an arrival event to occur.

In some embodiments, an arrival event is only generated if mobile device 102 enters second zone 302c within a specified duration of time after information content 301 is displayed on mobile device 102. In such cases, this specified duration of time can be included with location content 302 or can be calculated in some other manner. Also, in some embodiments, an arrival event may be created regardless of the duration of time that has passed since the information display event has occurred.

The present invention can use the occurrence of an arrival event to determine some further action to perform. In some embodiments, the present invention can implement an advertising platform that charges advertisers only when (or charges a premium when) an arrival event occurs rather than charging the advertiser for each time the advertisement is displayed. In this way, an advertiser can know that it will only be charged for advertisements that appear to have been effective (because the viewer of the advertisement came to the desired location).

The present invention can also use the occurrence of the arrival event to determine to display additional information on mobile device 102. For example, if location 310 desires to display a first advertisement on mobile devices that are within four blocks of the location, and then display a second, more detailed, advertisement on any of the mobile devices that then come within one block of the location, location 310 can provide the necessary information to cause these advertisements to be displayed on the appropriate mobile devices at the appropriate time.

In some embodiments, a mobile application can be provided to mobile devices to enable the mobile devices to receive information content and generate arrival events at an appropriate time. Whether the logic for performing these functions executes on the mobile device or on the server computing system is not essential to the invention. For example, a mobile device can be configured to transmit its GPS coordinates to server computing system 101a and to receive information content for display. In this example, the mobile device performs minimal functionality while server computing system 101a uses the reported GPS coordinates to identify when to display information and to determine when an arrival event has occurred.

In contrast, in some embodiments, the mobile device can receive information and location content from server computing system 101a and use this content to determine when information should be displayed and when an arrival event has occurred with the occurrence being reported back to server computing system 101a. Accordingly, these and other functions of the present invention can be performed by various devices in computer environment 100.

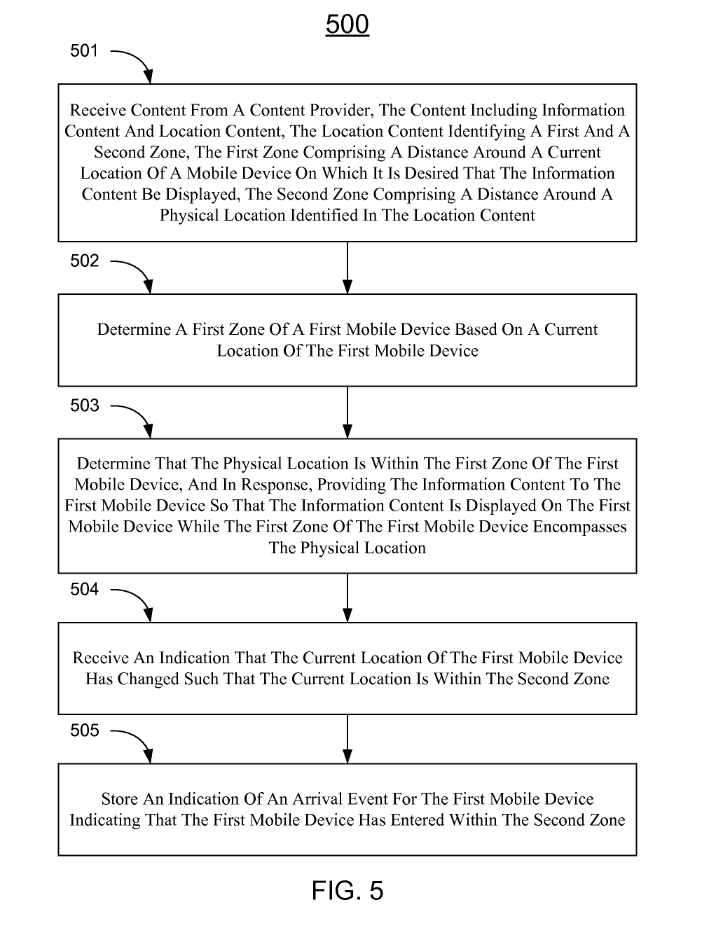

FIG. 5 illustrates a flowchart of an exemplary method 500 for providing information to a mobile device based on the location of the mobile device. Method 500 will be described with reference to FIGS. 3A-3C.

Method 500 includes an act 501 of receiving content from a content provider, the content including information content and location content, the location content identifying a first and a second zone, the first zone comprising a distance around a current location of a mobile device on which it is desired that the information content be displayed, the second zone comprising a distance around a physical location identified in the location content. For example, server computing system 101a can receive content such as shown in data structure 300 from server computing system 101b.

Method 500 includes an act 502 of determining a first zone of a first mobile device based on a current location of the first mobile device. For example, server computing system 101a can receive GPS coordinates or other location information from mobile device 102 and determine a first zone around a current location of the mobile device.

Method 500 includes an act 503 of determining that the physical location is within the first zone of the first mobile device, and in response, providing the information content to the first mobile device so that the information content is displayed on the first mobile device while the first zone of the first mobile device encompasses the physical location. For example, server computing device 101a can determine that the first zone defined around the current location of mobile device 102 encompasses location 310 and can provide information content 301 for display on mobile device 102.

Method 500 includes an act 504 of receiving an indication that the current location of the first mobile device has changed such that the current location is within the second zone. For example, server computing system 101a can determine from location information received from mobile device 102 that mobile device 102 is located within the second zone 302c.

Method 500 includes an act 505 of storing an indication of an arrival event for the first mobile device indicating that the first mobile device has entered within the second zone. For example, server computing system 101a can store an arrival event indication for later use such as in determining an amount to charge for displaying the information content, in determining further information to display, etc.

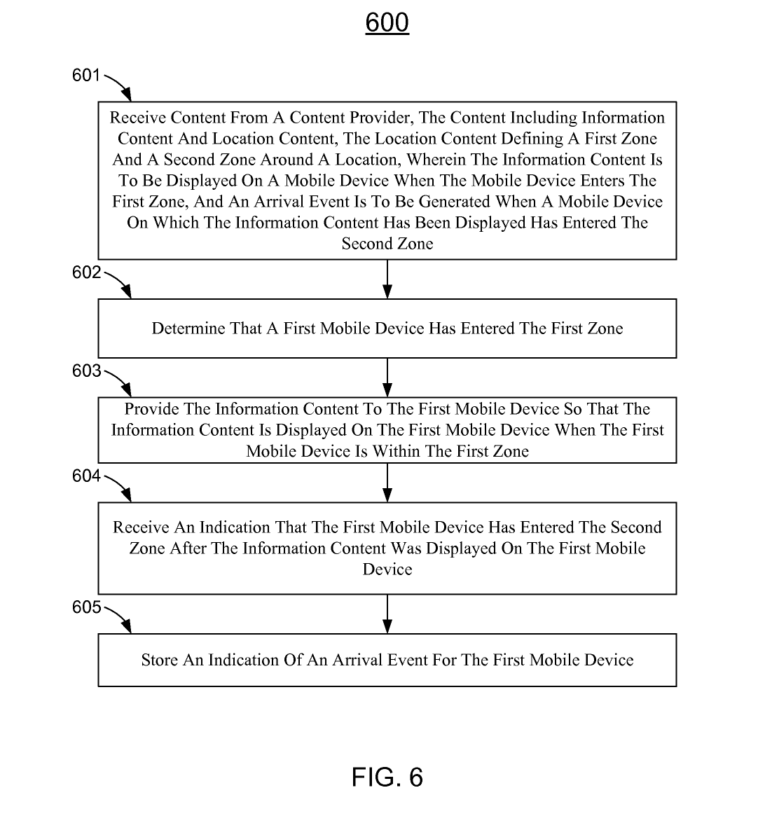

FIG. 6 illustrates a flowchart of an exemplary method 600 for providing information to a mobile device based on the location of the mobile device. Method 600 will be described with reference to FIGS. 4A-4C.

Method 600 includes an act 601 of receiving content from a content provider, the content including information content and location content, the location content defining a first zone and a second zone around a location, wherein the information content is to be displayed on a mobile device when the mobile device enters the first zone, and an arrival event is to be generated when a mobile device on which the information content has been displayed has entered the second zone. For example, server computing system 101a can receive content such as shown in data structure 300 from server computing system 101b.

Method 600 includes an act 602 of determining that a first mobile device has entered the first zone. For example, server computing system 101a can determine from information received from mobile device 102 that mobile device 102 has entered first zone 302b defined in location content 302.

Method 600 includes an act 603 of providing the information content to the first mobile device so that the information content is displayed on the first mobile device when the first mobile device is within the first zone. For example, server computing system 101a can provide information content 301 to mobile device 102 so that the information content is displayed on the mobile device while it is within first zone 302b.

Method 600 includes an act 604 of receiving an indication that the first mobile device has entered the second zone after the information content was displayed on the first mobile device. For example, server computing system 101a can receiving an indication from mobile device 102 that the mobile device has entered second zone 302c.

Method 600 includes an act 605 of storing an indication of an arrival event for the first mobile device. For example, server computing system 101a can store an arrival event indication. The occurrence of the arrival event can be used to determine further action to take including displaying additional information content, billing for the display of the information content, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a server computing system, for providing information to a mobile device based on the location of the mobile device, the method comprising:
receiving content from a content provider, the content including information content and location content, the location content identifying a first and a second zone, the first zone comprising a distance around a current location of a mobile device on which it is desired that the information content be displayed, the second zone comprising a distance around a physical location identified in the location content;
determining a first zone of a first mobile device based on a current location of the first mobile device;
determining that the physical location is within the first zone of the first mobile device, and in response, providing the information content to the first mobile device so that the information content is displayed on the first mobile device when the first zone of the first mobile device encompasses the physical location;
receiving an indication that the current location of the first mobile device has changed such that the current location is within the second zone; and
storing an indication of an arrival event for the first mobile device indicating that the first mobile device has entered within the second zone.

2. The method of claim 1, further comprising:
in response to the arrival event, providing a promo code, a bar code, or a more detailed advertisement to the first mobile device.

3. The method of claim 2, wherein the additional information content that is provided is based one or more of:
a duration of time between when the first mobile device enters the first and second zones; or
a frequency with which the first mobile device enters the second zone.

4. The method of claim 1, wherein the first or second zones are defined by one of:
a radius around the location; or
a plurality of coordinates defining the first or second zone.

5. The method of claim 2, wherein the information content comprises advertising, tour, or real estate information content.

6. The method of claim 1, further comprising:
calculating an amount to charge the content provider based on the occurrence of the arrival event.

7. The method of claim 1, wherein the first zone of the first mobile device is determined based on GPS coordinates of the first mobile device.

8. A method, performed by a server computing system, for providing information to a mobile device based on the location of the mobile device, the method comprising:
receiving content from a content provider, the content including information content and location content, the location content defining a first zone and a second zone around a location, wherein the information content is to be displayed on a mobile device when the mobile device enters the first zone, and an arrival event is to be generated when a mobile device on which the information content has been displayed has entered the second zone;
determining that a first mobile device has entered the first zone;
providing the information content to the first mobile device so that the information content is displayed on the first mobile device when the first mobile device is within the first zone;
receiving an indication that the first mobile device has entered the second zone after the information content was displayed on the first mobile device; and
storing an indication of an arrival event for the first mobile device.

9. The method of claim 8, wherein the server computing system determines that the first mobile device has entered the first and second zones based on GPS coordinates of the first mobile device.

10. The method of claim 9, wherein the physical address comprises GPS coordinates or a physical location of the content provider.

11. The method of claim 8, further comprising:
in response to the arrival event, providing additional information content to the first mobile device.

12. The method of claim 11, wherein the additional information content that is provided is based on one of:
a duration of time between when the first mobile device enters the first and second zones; or
a frequency with which the first mobile device enters the first or second zone.

13. The method of claim 11, wherein the information content includes an advertisement, and the additional information content comprises a more detailed advertisement.

14. The method of claim 11, wherein the information content comprises advertising, tour, or real estate information content.

15. The method of claim 8, further comprising:
calculating an amount to charge the content provider based on the occurrence of the arrival event.

16. The method of claim 8, wherein the first or second zones are defined by one of:
a radius around the location; or
a plurality of coordinates defining the first or second zone.

17. One or more computer storage media storing computer executable instructions which when executed by one or more processors perform a method for providing information content for display on a mobile device based on the location of the mobile device, the method comprising:
receiving information content and location content, the location content defining a first zone at which the advertisement content is to be displayed on a mobile device and a second zone at which an arrival event is to be generated indicating that a mobile device on which the advertisement content has been displayed has entered the second zone;
determining that the first mobile device is within the first zone defined in the location content;
providing the information content for display on the first mobile device so that the information content is displayed on the first mobile device when the first mobile device is within the first location;
determining that the first mobile device is within the second zone defined in the location content;
generating an arrival event indicating that the first mobile device entered the second zone after the information content was displayed on the first mobile device.

18. The one or more computer storage media of claim 17, wherein the method is performed by:
a server computing system;
the mobile device; or
both the server and the mobile device.

19. The one or more computer storage media of claim 17, wherein the first zone is defined as one of:
a zone around the current location of the mobile device; or
a zone around a physical location associated with the information content.

20. The one or more computer storage media of claim 17, wherein the information content comprises one or more of:
advertisement content regarding a retail location;
advertisement content regarding an amusement location;
real estate content regarding a real estate location;
informational content regarding a historical or tourist site; or
event content regarding an event at a location.
